(19) United States
(12) Patent Application Publication
(10) Pub. No.: US 2025/0283484 A1
(43) Pub. Date: Sep. 11, 2025

(54) CONTACT BODY FOR AT LEAST ONE LIQUID PUMP IN MOTOR VEHICLES

(71) Applicant: BÜHLER MOTOR GMBH, Nürnberg (DE)

(72) Inventors: Martin Gundermann, Nürnberg (DE); Harald Rausch, Fürth (DE); Andrea Bindig, Nürnberg (DE); Christian Zimmerer, Pottenstein (DE)

(73) Assignee: BÜHLER MOTOR GMBH, Nürnberg (DE)

(21) Appl. No.: 19/215,884

(22) Filed: May 22, 2025

Related U.S. Application Data
(63) Continuation of application No. PCT/EP2023/081461, filed on Nov. 10, 2023.

(30) Foreign Application Priority Data
Nov. 28, 2022 (DE) 10 2022 131 340.9

(51) Int. Cl. F04D 29/60; F04D 29/66

(52) U.S. Cl. CPC F04D 29/605; F04D 29/669

(57) ABSTRACT

A contact body for at least one liquid pump in motor vehicles, comprising a damping element which has an inner surface, within which a liquid pump can be held, an outer surface, and a target body, wherein the damping element has on its outer surface at least one projection with at least one receiving contour for the target body, and wherein the at least one projection rests flat on a region of the target body.

### CROSS-REFERENCE TO RELATED APPLICATIONS

The present patent application claims priority from German Application No. DE 10 2022 131 340.9, filed Nov. 28, 2022, which was filed as PCT application No. PCT/EP2023/081461 (International Publication No. WO/2024/115078, published on Jun. 6, 2024). Both applications are incorporated herein by reference in their entirety.

### BACKGROUND OF THE INVENTION

### Field of the Invention

The invention relates to a contact body for at least one liquid pump in motor vehicles comprising a damping element and a target body.

### DESCRIPTION OF RELATED ART INCLUDING INFORMATION DISCLOSED UNDER 37 CFR 1.97 AND 1.98

It is known to use liquid pumps, for example, to transport coolant within a motor vehicle. In this connection, there are already holders for liquid pumps, in the receiving openings of which the liquid pumps can be accommodated in order to hold them in position. Elastic damping elements are preferably used as such holders to minimize vibrations transmitted to the pump. This can be a major problem, especially with rigid holders, since sound can be transmitted into the vehicle cabin, which can be disturbing to the occupants. However, the holders or damping elements with the liquid pumps mounted on them must be fixed in a suitable manner at the place of use in the motor vehicle—for example, by screwing them to the body. However, in most cases the damping elements should not or cannot be attached directly to the vehicle. For this reason, so-called target bodies can be provided as intermediate elements between the damping element and the intended fastening location in the motor vehicle. It must be ensured that the damping element can be connected safely, firmly, and stably to the target body without causing excessive assembly effort.

The object of the invention is to propose a device that enables liquid pumps in motor vehicles to be securely and stably mounted. In particular, a device is to be proposed which comprises a damping element and suitable means for fixing the supported liquid pump in the motor vehicle in a simple, secure, and stable manner. The production and assembly costs are to be kept as low as possible.

### BRIEF SUMMARY OF THE INVENTION

A contact body for at least one liquid pump in motor vehicles comprises a damping element having an inner surface within which a liquid pump can be held, an outer surface, and a target body. The damping element on its outer surface has at least one projection with at least one receiving contour for the target body. At least one projection lies flat on a region of the target body.

The contact body according to the invention advantageously enables the fastening of a liquid pump in motor vehicles, which can be held securely and so as to be vibration-resistant within the damping element. The target body serves as an intermediate element between the damping element and the final attachment point in the motor vehicle and can be specifically designed according to requirements. By having at least one, preferably at least two, projections on the damping element, there are no limits to the needs-based design of the receiving contour(s), in particular by providing an optimized surface area of the projection. The receiving contour serves as a centering and form-fit to the target body as a counterpart. The receiving contour can be optimally designed with respect to the shape of the target body in order to be able to receive it securely and fix it with a minimized risk of slipping out. The target body, in turn, can be adapted to the specific fixation options in a wide variety of motor vehicles, according to requirements. This makes it advantageous to hold liquid pumps individually according to the conditions in the respective motor vehicle type. The flat support of the target body on the projection promotes a stable connection to the damping element. Unwanted forces acting upon the target body during vehicle use are minimized by the extended contact surface in the case of sufficiently high preload. Preferably at least two projections on the damping element advantageously lead to an even better support surface for the target body. A simple assembly of the target body in the receiving contour is advantageously possible, since the target body has only to be inserted. A stable and secure connection is still guaranteed. The other end piece of the target body (or several ends) can, for example, be screwed to the body of the motor vehicle. The receiving contour can be taken into account or created during the manufacturing process (e.g., during injection molding) or can be added subsequently by removing material (punching, milling, or the like).

In an embodiment, the damping element has an uninterrupted annular contour with chamfers and/or curves on its inner surface. A round and uninterrupted inner diameter allows for greater surface pressure on the liquid pump and more stability.

In a further embodiment, the damping element comprises at least one recess, which extends from the inner surface to the outer surface. Preferably, several recesses are provided distributed over the circumference, which correspond to counterparts on the pump (for example, screws). The recesses serve to improve fixation and prevent accidental detachment; the counterpart snaps into the recesses (locking-hook principle). However, it is also conceivable not to provide these recesses at all, with the resulting advantage that the liquid pump remains rotatable during assembly.

At least one first receiving contour can be provided which has legs that are connected or formed symmetrically to one another via a connecting bridge. The target body can also have a symmetrical contour, which can be used to hold it within this receiving contour. The first receiving contour therefore has a continuous, uninterrupted contour, which can, for example, extend over the majority of the projection.

According to a preferred embodiment, at least one second receiving contour is provided, which is formed in two parts by a first and a second contour element, wherein the two contour elements have shapes different from and asymmetrical to one another.

The different shaping of the contour elements of the second receiving contour (especially in comparison to the first receiving contour) enables, on the one hand, individual adaptations of the receiving contours with respect to (the shape of) the target bodies and thus with respect to a specific application. On the other hand, confusion-free assembly is supported, since the target body can be pushed into the receiving contour only in a unique assembly direction and on a unique side (Poka Yoke principle).

The projections may preferably have first receiving contours on one projection of the damping element and second receiving contours on another projection of the damping element. It is also conceivable to create only first or second receiving contours, depending upon the specifications of the fastening points in the motor vehicle.

The contour elements are provided on or in the second receiving contour. Preferably, the contour elements are formed differently from and/or asymmetrically to one another. This may mean, for example, that the first contour element has a completely different shape than the second contour element. For example, it is possible for the first contour element to be substantially elongated or rod-shaped and for the second contour element to have a substantially round or arc-like shape. Fork-like, meander-like, wave-like, hook-like, bent, or other shapes known to the person skilled in the art are also conceivable. In principle, a symmetrical shape, e.g., two mirrored arches, would also be possible. Overall, the embodiment advantageously ensures that the receiving contour is designed in a way that eliminates the possibility of confusion.

In the exemplary embodiment, the two contour elements are not connected, but are (superficially) formed separately and thus (superficially) in two parts. It would also be conceivable to provide both contour elements with a connecting plane so that they form a continuous contour element or a continuous receiving contour. However, the separation of the two contour elements forms a kind of bridge or web made of the material of the projection of the damping element, which is advantageous for stiffening.

According to a further embodiment, an axial undercut is formed within the projection. This corresponds to the target body for better fixation and prevention of unintentional detachment according to the locking-hook principle and form-fit.

It can be provided that roundings and/or insertion bevels can be formed on at least one receiving contour. Such a contour benefits the mounting of the target body due to the improved centering option. The risk of slipping (or slipping out) is minimized.

Furthermore, it can be provided that the target body have at least one balcony that corresponds to the cantilever. The balcony may be provided at one end (or at several ends) of the target body, wherein the end forms an enlarged area at least in portions. This area facilitates the resting of the target body on the projection of the damping element due to an enlarged contact region. The balcony can be shaped in different ways—for example, as a semicircle or square. This may depend upon the specific requirements of the respective vehicle.

According to one embodiment, the target body comprises fastening arms which are connected in a form- and/or force-fit manner to the at least one receiving contour. The target body can have several—at least two-fastening arms, which are preferably formed in one piece with the target body, but can also be formed in two pieces. This allows the target body to be adapted to the number of multiple receiving contours on their respective projections of the damping element. The target body can have two fastening arms, each end of which can be inserted into a receiving contour.

According to a further embodiment, the fastening arms on the axial end faces substantially have the shape of the corresponding receiving contour. A confusion-free and stable holding of the target body via the fastening arms is thus advantageously possible within the receiving contour(s).

It can advantageously be provided that a liquid pump be accommodated in the inner surface of the damping element in a force- and/or form-fit manner. The inner surface can be adapted accordingly with respect to the surface structure of the inner surface and the diameter in order to be able to hold the liquid pump accordingly.

Furthermore, it can be provided that wing elements with screw eyes for fastening to a counter contour on a motor vehicle be formed on the target body. The counter contour can, for example, be a block in the engine compartment or the like with a thread to which the screw eyes of the wing elements of the target body can be screwed. Preferably, several wing elements are provided, but only a single wing element is also conceivable. The fastening can of course also be carried out using other force-fit and/or form-fit and/or material-fit methods on the correspondingly designed counter contour.

In particular, the contact body is designed to accommodate a plurality of liquid pumps. Advantageously, the contact body can thus accommodate several pumps via a damping element or via several (preferably connected) damping elements, wherein the contact body also has the other advantageous embodiments described above in this case. Consequently, several pumps can be mounted in parallel easily and in an uncomplicated fashion.

The damping element is preferably made of an elastic material, and the target body is made of a thermo-resistant material.

A rigid damping element of a liquid pump is usually not desired, since this would result in undesirable transmission of vibrations to the pump. This places the liquid pump and its components under continuous stress, which affects the overall service life of the liquid pump and promotes premature failure. Furthermore, a rigid holder can lead to increased noise, due, for example, to vibration transmission to the motor vehicle body, which can be disturbing to the motor vehicle's occupants. The damping element, or rather its material, can be selected so that it reduces vibrations of the liquid pump and shocks from the motor vehicle, while providing sufficient stability. At the same time, however, it must be selected in such a way that it shows a small deflection in order to avoid causing damage in the installation space. Acoustic decoupling of the liquid pump is advantageously promoted, and pulse-like stresses are absorbed. Furthermore, the elastic properties of the assembly are beneficial, because the liquid pump can be inserted more easily. If desired, the damping element can of course still be designed rigidly as a holder.

The thermo-resistant material of the target body reduces contraction and/or expansion of the target body, and thus prevents the target body from slipping out of the receiving contour of the damping element.

Suitable materials are well known to the person skilled in the art and can be selected according to the intended use. Examples include elastomers, other plastics, metals, or steel structures.

The invention is not limited to the mentioned exemplary embodiments.

Rather, all design variants that are implemented within the scope of the activities of a person skilled in the art and minor technical changes by a person skilled in the art are included.

The exemplary embodiments of the invention are explained in greater detail below on the basis of the drawings, in which:

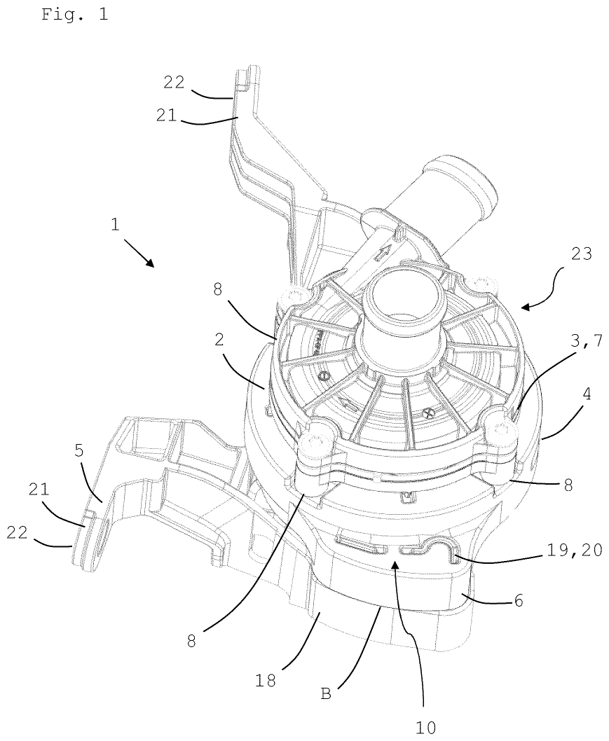

FIG. 1 shows an exemplary overview illustration of a contact body with a liquid pump mounted thereon according to one embodiment of the invention;

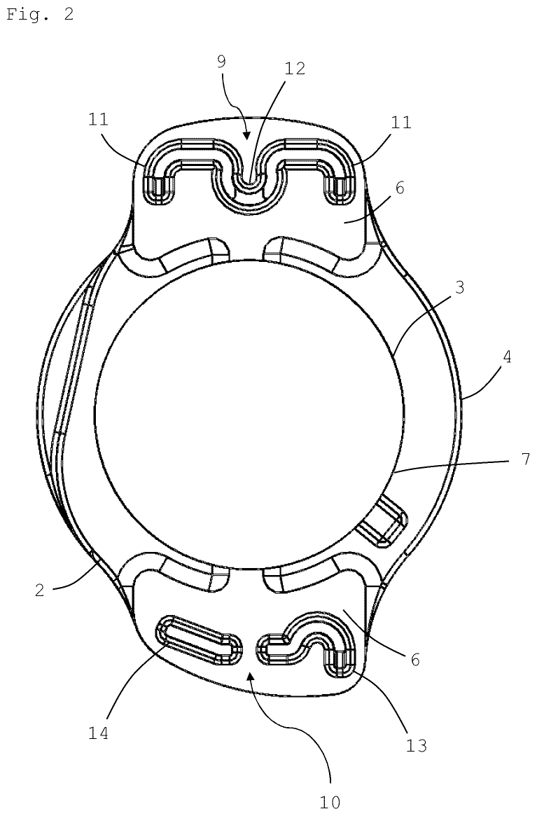

FIG. 2 shows a detail view of a damping element according to an embodiment of the invention;

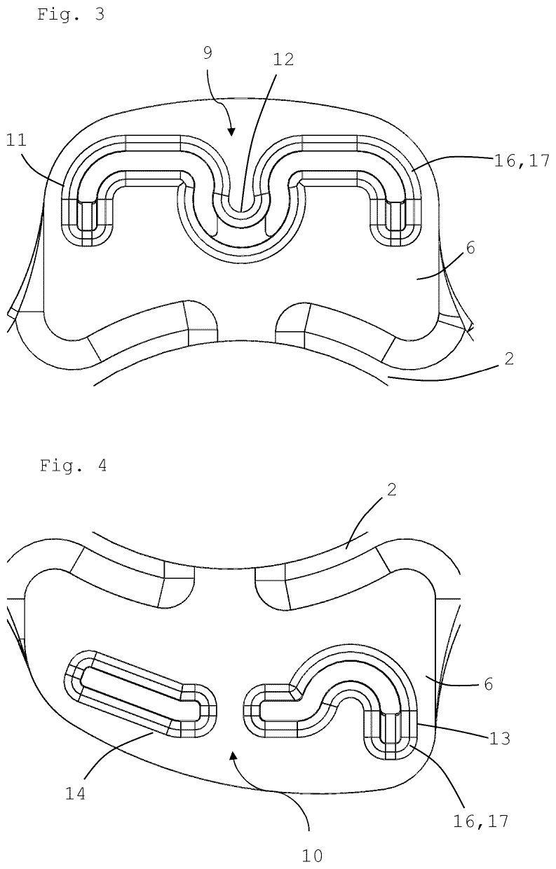

FIG. 3 shows a detail illustration from FIG. 2;

FIG. 4 shows a further detail illustration from FIG. 2;

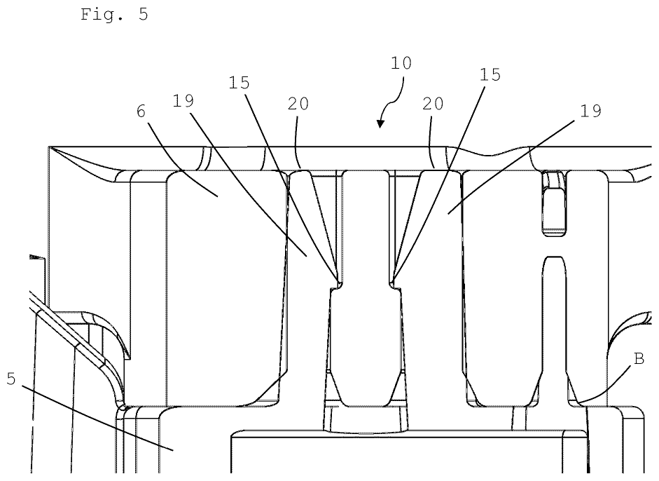

FIG. 5 shows a sectional illustration from FIG. 4.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes al technical equivalents that operate in a similar manner to accomplish a similar purpose.

FIG. 1 shows an exemplary overview illustration of a contact body 1 with a liquid pump 23 mounted thereon according to one embodiment. The contact body 1 can hold and stably fix a liquid pump in a motor vehicle—for example, by screwing it to the interior of the motor vehicle using a suitable counter contour (not shown). This counter contour can, for example, include a thread for a screw connection. The liquid pump 23 can, for example, transport cooling water, but all possible liquids used in the automotive sector are conceivable. By adapting the contact body 1, it is also possible to mount two or more liquid pumps 23 in parallel next to each other. The contact body 1 comprises a damping element 2 made of preferably elastic material, on or within the inner surface 3 of which the liquid pump 23 is arranged. By appropriately designing the inner surface 3, e.g., by an annular contour 7 with chamfers and/or roundings or by adapting the diameter of the damping element 2, or by providing an uninterrupted structure on the inner surface 3, the holding of the liquid pump 23 can be advantageously improved. In particular, this is through form-fit, but also through force-fit. Furthermore, recesses 8 can be provided on the damping element, which can correspond to corresponding projections on the liquid pump 23 (for example, screw domes of the liquid pump). The liquid pump 23 can thus be arranged in the damping element in a rotationally secure manner and locked with radial and axial securing. It is also possible to provide only a single recess 8, or it is also conceivable to provide no recess 8 at all, in order to be able to intentionally arrange the liquid pump 23 so as to be rotatable, if desired. The recesses 8 extend in each case from the inner surface 3 and the outer surface 4 of the damping element 2.

The contact body 1 has a target body 5 which can act as an intermediate element between the damping element 2 and a counter contour (fixing location) in the motor vehicle. The target body 5 can, for example, be a metal holder or consist of another, thermo-resistant material and comprises one or more wing elements 21 with screw eyes 22, with which the contact body 1 can be fastened in the installation space of the motor vehicle by means of the target body 5. The target body 5 can already be specified according to the type of motor vehicle, and the contact body 1 can be adapted accordingly. The contact body is usually screwed into a suitable location in the motor vehicle.

The damping element 2 has on its outer surface 4 at least one projection 6 with at least one receiving contour 9, 10 for the target body. In the exemplary embodiment of FIGS. 1 and 2, only the first receiving contour 9 on a projection 6 is visible, but this should not be understood as limiting. On two projections 6-which are preferably formed integrally with the damping element 2-only first receiving contours 9, or only second receiving contours 10, or first and second receiving contours 9, 10 can be provided. In the preferred embodiment, the contact body 1 has a damping element 2 with two projections 6, which have a first receiving contour 9 on one projection 6 and a second receiving contour 10 on the second projection 6, and each correspond to a fastening arm 20 of the target body 5. The fastening arms 20 are preferably located at the ends (or at the end) of the target body 5 in the region of the damping element 2 and, as can be seen on the axial end faces 20, comprise a shape corresponding to the respective receiving contour 9, 10 in order to be mounted and held securely and stably in the latter.

According to this embodiment, the target body 5 has at least one balcony 18 which is provided at or on a region of the target body 5 and forms an enlarged support surface with a region B of the damping element 2. A flat resting of the damping element 2 on the target body 5 is thus advantageously promoted. For example, two balconies 18 are provided to allow support on two sides of the damping element 2.

The contact body 1 according to the invention preferably comprises an elastically designed damping element 2. In principle, however, a rigid damping element 2 is also conceivable.

FIG. 2 shows a detail view of a damping element 2 according to an embodiment with a first receiving contour 9 on a projection 6 of the damping element 2 and a second receiving contour 10 on a further projection 6 of the damping element 2. Also visible is the annular contour 7, which in the exemplary embodiment is formed without interruption on the inner surface 3 of the damping element 2.

As can be seen in conjunction with the more detailed view of the first receiving contour 9 in FIG. 3, the first receiving contour 9 according to this exemplary embodiment has two legs 11 which are symmetrically connected to one another via a connecting bridge 12-more precisely, forming a mirror-symmetrical and/or uninterrupted receiving contour 9. Alternatively, the exact design of the legs can be chosen as desired.

As can be further seen in FIG. 2 in conjunction with the more detailed view of the second receiving contour 10 in FIG. 4, the second receiving contour 10 according to this exemplary embodiment has a first contour element 13 and a second contour element 14. The contour elements 13, 14 are preferably different from and asymmetrical to one another. In the exemplary embodiment, the first contour element 13 has essentially an arcuate or fork-shaped form, and the second contour element 14 has essentially an elongated shape and is not designed as a continuous receiving contour. However, completely different shapes are also conceivable, such as fork-like, meander-like, wave-like, hook-like, bent, or other shapes known to the person skilled in the art.

The fact that a first receiving contour 9 is symmetrical and a second receiving contour 10 is asymmetrical advantageously supports a quick and confusion-proof mounting of the target body 5 on or in the damping element 2. Alternatively, of course, only a symmetrical or an asymmetrical receiving contour 9, 10 may be provided.

For example, the receiving contours 9, 10 may already be provided or created in the manufacturing process of the damping element 2, or may be added afterwards by removing material. The receiving contours 9, 10 have roundings 16 and insertion bevels 17 to facilitate the mounting of the fastening arms 19 of the target body 5.

As already described, the axial end faces 20 of the fastening arms 19 have the shapes corresponding to the first and/or second receiving contours 9, 10 in order to accordingly be able to mount the target body 5 in the damping element 2 in such a way that there is no risk of confusion, and it can be mounted easily without the use of force.

FIG. 5 further shows a partial sectional view from FIG. 4, i.e., a view of a projection 6 of the damping element 2 with a second receiving contour 10 within which the fastening arms 19 of the target body 5 are arranged, wherein the contact between the target body 5 and the projection 6 takes place via the region B. The different design of the fastening arms 19 on the axial end faces 20 can be seen with respect to the asymmetrically designed contour elements 13, 14 of the second receiving contour 10. The fastening arms 19 can be advantageously fixed and secured by means of axial undercuts 15 provided in the second receiving contour 10. The risk of accidental detachment is minimized.

The liquid pump is designed to transport water, coolant, oil, or any other liquid and is not specifically restricted in this respect.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE NUMBERS

1 Contact body
2 Damping element
3 Inner surface
4 Outer surface
5 Target body
6 Projection
7 Annular contour
8 Recess
9 First receiving contour
10 Second receiving contour
11 Leg
12 Connecting bridge
13 First contour element
14 Second contour element
15 Axial undercut
16 Rounding
17 Insertion bevel
18 Balcony
19 Fastening arm
20 Axial end face
21 Wing element
22 Screw eye
23 Liquid pump
B Region of the target body

What is claimed is:

1. A contact body for at least one liquid pump in motor vehicles, the contact body comprising a damping element which has an inner surface, within which a liquid pump can be held, an outer surface, and a target body, wherein the damping element has on its outer surface at least one projection with at least one receiving contour for the target body, and wherein the at least one projection rests flat on a region of the target body.

2. The contact body according to claim 1, wherein the damping element has on its inner surface an uninterrupted annular contour with chamfers and/or roundings.

3. The contact body according to claim 1, wherein the damping element comprises at least one recess extending from the inner surface to the outer surface.

4. The contact body according to claim 1, wherein at least one first receiving contour is provided which has legs which are symmetrically connected to one another via a connecting bridge.

5. The contact body according to claim 4, wherein at least one second receiving contour is provided, which is formed in two parts by a first and second contour element, wherein the two contour elements have shapes different from and asymmetrical to one another.

6. The contact body according to claim 1, wherein an axial undercut is formed within the projection.

7. The contact body according to claim 1, wherein roundings and/or insertion bevels are formed on at least one receiving contour.

8. The contact body according to claim 1, wherein the target body has at least one balcony which corresponds to the projection.

9. The contact body according to claim 1, wherein the target body comprises fastening arms which are connected to the at least one receiving contour in a form-fit and/or force-fit manner.

10. The contact body according to claim 9, wherein the fastening arms on the axial end faces have substantially the shape of the corresponding receiving contour.

11. The contact body according to claim 1, wherein a liquid pump is received in a force- and/or form-fit manner in the inner surface of the damping element.

12. The contact body according to claim 1, wherein wing elements with screw eyes for fastening to a counter contour on a motor vehicle are formed on the target body.

13. The contact body according to claim 1, wherein the contact body is designed to receive a plurality of liquid pumps.

14. The contact body according to claim 1, wherein the damping element is formed from an elastic material, and the target body is formed from a thermo-resistant material.
